(19) United States
(12) Patent Application Publication
(10) Pub. No.: US 2026/0266333 A1
(43) Pub. Date: Sep. 10, 2026

(54) WHEEL BEARING ASSEMBLY AND ASSEMBLING METHOD

(71) Applicant: AKTIEBOLAGET SKF, GOTEBORG (SE)

(72) Inventors: Johannes Klaus ZANG, Schweinfurt (DE); Libin ZHANG, Kunshan (CN)

(21) Appl. No.: 19/553,562

(22) Filed: Mar. 2, 2026

(30) Foreign Application Priority Data
Mar. 10, 2025 (CN) 202510277334.1

(51) Int. Cl. F16C 19/38; F16C 33/66; F16C 33/78

(52) U.S. Cl. CPC F16C 19/386; F16C 33/6655; F16C 33/7813; F16C 2326/02

(57) ABSTRACT

A wheel bearing assembly includes a bearing having an outer ring, an inner ring, rolling elements between the outer ring and the inner ring and a hub element. The inner ring is mounted on a shaft section. A first end of the hub element is connected to a braking element and a second end of the hub section has an axial first section on a radial outer side of outer ring and a radial second section extending radially inward from the axial first section. A sealing ring is arranged between an outer diameter periphery of the outer ring (or an outer hub ring that surrounds the outer ring) and the radial second section of the hub element to seal a clearance between the radial second section of the hub element and the at least one outer ring.

### CROSS-REFERENCE

This application claims priority to Chinese patent application no. 202510277334.1 filed on Mar. 10, 2025, the contents of which are fully incorporated herein by reference.

### TECHNOLOGICAL FIELD

The present disclosure relates to the technical field of wheel bearing assemblies.

The present disclosure is an improvement to the wheel bearing assembly in the patent publication number WO 2022/008272 A1 (corresponding to US Patent Publication 2023/0265881) of the same applicant. The entire content of US Patent Publication 2023/0265881 is incorporated herein by reference.

### BACKGROUND

Wheel bearing assemblies are known, especially for use in such as THU2 type bearing unit of Aktiebolaget SKF. This can also be found in WO 2022/008272 A1 (corresponding to US Patent Publication 2023/026588). As shown by the horizontal dashed line in FIG. 1, during operation, gear may oil will flow to the wheel end through the clearance between the axle 28 and the shaft section 62 or flow to the inside braking element 30 through the clearance between the inner ring 60 and the shaft section 62, resulting in oil leakage. Therefore, there is room for further improvement.

### SUMMARY

The present disclosure overcomes the disadvantage of oil leakage in the prior art and provides a wheel bearing assembly with a simple structure while providing excellent sealing effect.

According to aspects of the disclosure, a wheel bearing assembly, used for bearing the rotation of an axle, includes a bearing and a hub element. The bearing includes an outer ring, an inner ring, and rolling elements interposed between the outer ring and the inner ring. The axle is fitted into a shaft section coupled to the inner ring on the radial inner side of the inner ring. One end of the axle extends axially beyond the bearing and forms a flange extending in the radial outward direction of the axle. One end of the hub element is connected to a braking element for braking the axle, and the other end of the hub element is has a first section extending substantially axially on the radial outer side of the outer ring of the bearing and a second section extending substantially in the radial inward direction of the axle. The second section is clamped axially between the flange and the outer ring of the bearing. The flange, the second section of the hub element and the outer ring of the bearing can be fixed together (e.g., by means of fastener). A sealing ring is arranged between the outer diameter periphery on the lateral surface of the outer ring (or the outer ring hub fitted radially outward of the outer ring, if it is present) of the bearing and the second section of the adjacent hub element so as to seal the clearance between the second section of the hub element and the outer ring (in the case where the outer ring hub is arranged, seal the clearance between the second section of the hub element and the outer ring hub), thereby sealing the lubricating oil flow path.

Compared with the prior art, the present disclosure can solve the oil leakage problem of existing wheel bearing assembly (especially THU2 type bearing unit) in a simple way, while also taking into account the internal space design of the wheel bearing assembly.

Preferably, a recess for receiving the sealing ring is formed at the outer diameter periphery on the lateral surface of the outer ring (or the outer ring hub fitted radially outward of the outer ring, if present) of the bearing. In particular, the recess is in the shape of a circular arc. In this way, the sealing ring can be arranged more stably.

Preferably, the transition portion between the first section and the second section of the hub element is formed in the shape of a circular arc chamfer. This also facilitates further improvement in the sealing effect of the sealing ring.

Preferably, sealant is applied (in the oil leakage path) between the second section of the hub element and the flange. Therefore, with respect to two typical oil leakage paths in this type of wheel bearing assembly, the inventors consider the internal structure of the wheel bearing assembly, adopt different sealing means to make combination, and finally achieve a good sealing and leak prevention effect.

In addition, advantageously, the bearing is a double row tapered roller bearing, and the two outer rings of the double row tapered roller bearing are formed in one piece. Furthermore, a fastener passes axially through the flange, the second section of the hub element, and the outer ring of the bearing so as to fix the three together. These settings also apply to this type of wheel bearing assembly.

The present disclosure also involves an assembling method for the wheel bearing assembly, and it includes the following steps: preforming a recess for receiving the sealing ring at the outer diameter periphery on the lateral surface of the outer ring (or the outer ring hub fitted radially outward of the outer ring, if present) of the bearing, pre-placing the sealing ring into the recess, and assembling the outer ring (or the outer ring hub fitted radially outward of the outer ring, if present) with the sealing ring placed on into the hub element.

### BRIEF DESCRIPTION OF THE DRAWINGS

The combination of features in the Description and the Drawings is only exemplary, and these features may exist separately or in combination in other ways.

FIG. 1 is a sectional side elevational view of a conventional wheel bearing assembly.

FIG. 2 is a schematic cross-sectional view of a portion of a wheel bearing assembly according to a first embodiment of the present disclosure.

FIG. 3 is an enlarged view of the wheel bearing assembly of FIG. 2.

FIG. 4 is a perspective view of the wheel bearing assembly of FIG. 2.

FIG. 5 is a schematic cross-sectional view of a wheel bearing assembly according to a second embodiment of the present disclosure.

### DETAILED DESCRIPTION

The embodiments of the present disclosure will be described below with reference to the accompanying drawings.

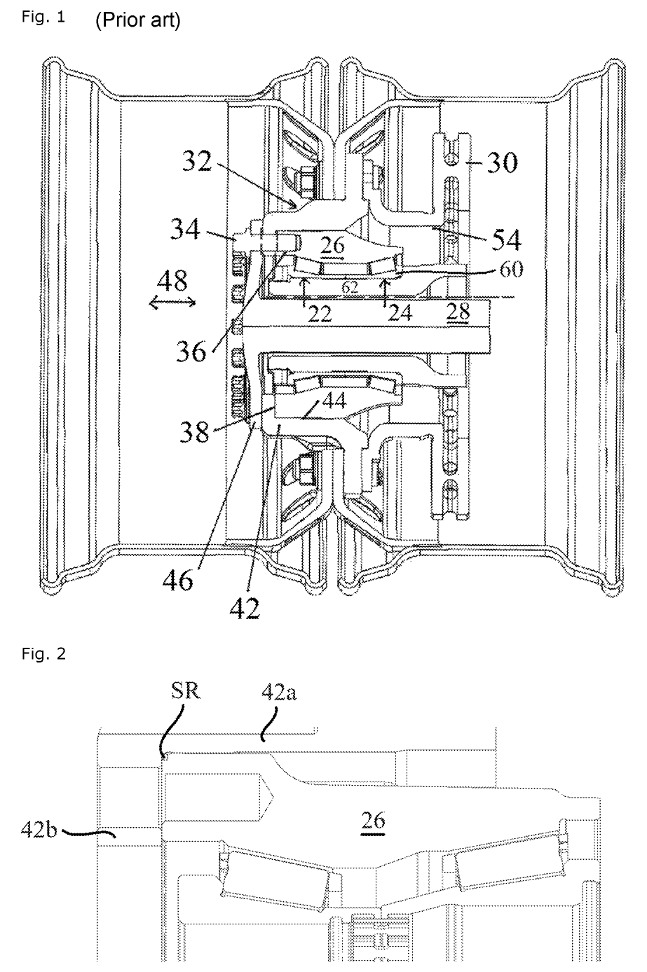

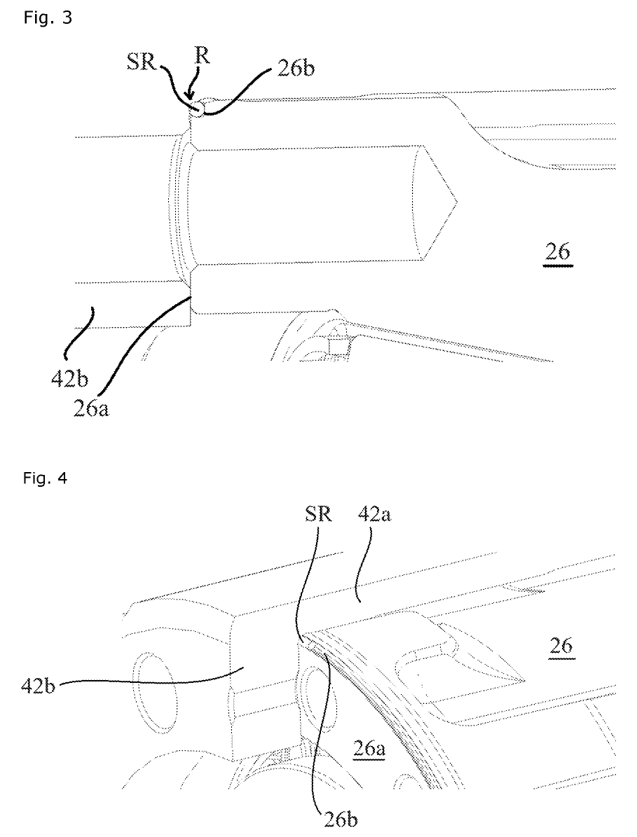

FIG. 1 is a schematic diagram of a wheel bearing assembly in the prior art. In this regard, reference can also be made to FIGS. 2 and 3 in the prior art document WO 2022/008272 A1 (corresponding to US Patent Publication 2023/0265881). Compared to this, FIG. 1 of the present disclosure also adds three dashed lines (two vertical and one horizontal red dashed lines) to more clearly show the flow path(s) of gear oil during operation. Of course, in addition to the flow path shown by the horizontal dashed line mentioned above, gear oil may also flow through the interior of the bearing (such as through rolling elements) or through the clearance between the inner ring 60 of the bearing and the shaft section 62 to the inside braking element, but this is not the focus of the present disclosure and will not be repeated here.

In FIG. 1, the bearing is a double row tapered roller bearing having two rows of rolling elements 22 and 24. The two outer raceways of the bearing are formed in one piece, i.e., as a common outer ring 26. The two inner rings 60 of the bearing can be fixedly screwed onto the external threads of shaft section 62 by using, for example, nuts (not shown here, refer to elements 66 in the aforementioned prior art document), and an axle 28 extends through the shaft section 62 (the axial direction of the axle 28 is indicated by reference numeral 48). The braking element 30 of the wheel bearing assembly is rigidly attached to the bearing ring 26 through a connecting unit 32 of the wheel bearing assembly, and the braking element 30 is constructed as a braking disc element. The braking element 30 is arranged on the inboard side of the wheel bearing assembly. The connecting unit 32 includes a hub element 42, a fastener such as a screw 34, a flange 46 of the axle, and additional screw(s) that attach the braking element 30 to the hub element. The fastener 34 passes through the flange 46 and through the opening of the hub element and is screwed into the opening 36 of the outer ring 26 of the bearing. Therefore, the flange 46 and the hub element 42 are also attached to the outer ring 26 of the bearing. The opening 36 is arranged on the end side 38 of the bearing ring. Advantageously, the bearing ring does not have a shoulder on its radial outer side that allows screws to be screwed in to attach the drive shaft and/or the hub element 42.

FIGS. 2 to 4 illustrate a first embodiment of a wheel bearing assembly according to the present disclosure. The hub element 42 includes a first section 42a extending in the axial direction of the axle 28 and a second section 42b continuing to extend in the radial inward direction of the axle 28. A sealing ring SR is arranged between the outer diameter periphery on the lateral surface 26a of the outer ring 26 of the bearing and the second section 42b of the hub element 42. It should be noted that the “lateral surface 26a” refers to the surface of the outer ring 26 adjacent to the second section 42b of the hub element 42, and the “outer diameter periphery” refers to the radially outermost portion of the second section 42b. In other words, a sealing ring SR is provided at the radially outermost position on the lateral surface 26a of the outer ring 26, which approximately corresponds to the transition portion R between the first section 42a of the hub element 42 and the second section 42b of the hub element 42 (see FIG. 3). The sealing ring SR can be configured as an O-ring seal. Thus the gear oil flow path shown by the vertical dashed line on the right side in FIG. 1 can be sealed.

As shown in FIGS. 3 and 4, the outer diameter periphery on the lateral surface 26a of the outer ring 26 can be pre-formed with a recess 26b for receiving the sealing ring SR, so as to facilitate a placement of the sealing ring SR into the recess 26b. Furthermore, the cross-section of the recess 26b can also be of a circular arc shape (especially at the bottom/trough of the recess), and the circular arc is preferably smooth, with a curvature roughly consistent with the curvature of the sealing ring contour. The above structure can make the arrangement of the sealing ring more stable, thereby improving the sealing effect. In addition, this also makes it possible to pre-arrange the sealing ring. “Reserving or pre-machining a recess for placing the sealing ring on the radially outermost position on the lateral surface of the outer ring of the bearing” involves prefabricating the outer ring to be different from traditional outer ring during the manufacturing of bearing, which is not easily to be perceived by those skilled in the art.

Particularly, as clearly shown in FIG. 3, the transition portion R between the first section 42a and the second section 42b of the hub element 42 is constructed in the shape of a circular arc chamfer. By means of a smooth match in curvature among the circular arc chamfer of the transition portion R, the curvature of the sealing ring SR, and the circular arc shape of the recess 26b mentioned above, it is beneficial to ensure that the sealing ring SR forms a smooth and stable seal between the outer ring 26 and the hub element 42.

In addition, with respect to the gear oil flow path shown by the left vertical dashed line in FIG. 1, sealant can be applied between the second section 42b of the hub element 42 and the flange 46. As a result, by separately and selectively setting up “sealing ring” and “sealant” for these two typical gear oil flow paths and combining them together to obtain an overall solution, it effectively improves the oil leakage problem of the existing wheel bearing assembly, while also achieving a good compromise between the sealing effect and the compact space inside the wheel bearing assembly.

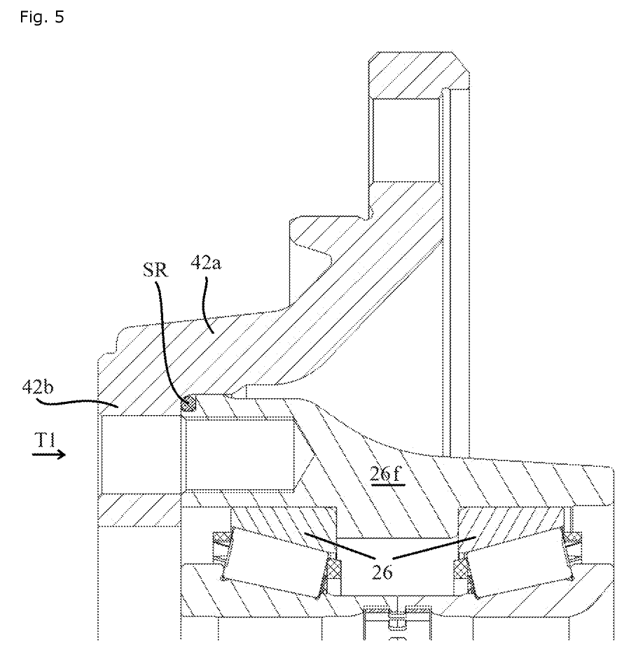

As a variant, FIG. 5 illustrates a second embodiment of the wheel bearing assembly according to the present disclosure. As shown in FIG. 5, an outer ring hub 26f is further provided on the radial outer side of the two outer rings 26. The arrow T1 in FIG. 5 indicates the direction for inserting the fastener 34. At this time, the fastener 34 passes through the flange 46, the second section 42b of the hub element 42, and finally into the outer ring hub 26f (instead of directly into the outer ring 26), thereby being able to be fixed with the outer ring. In this case, according to the spirit of the present disclosure, the sealing ring SR should be arranged at the outer diameter periphery of the outer ring hub 26f, instead of being arranged at the outer diameter periphery of the outer ring 26 as in the first embodiment. In other words, if several outer ring hubs 26f are fitted radially outward of the outer ring 26, then the sealing ring SR should be arranged at the position of the radially outermost outer ring hub 26f with respect to the transition portion R between the first section 42a and the second section 42b of the hub element 42. This also belongs to the concept of the present disclosure and is within the protection scope of the present disclosure.

In the second embodiment, the recess 6b is preformed at the outer diameter periphery of the lateral surface of the outer ring hub 26f, instead of being formed at the outer diameter periphery of the lateral surface of the outer ring 26 as in the first embodiment. Furthermore, as shown in FIG. 5, compared to the first embodiment, the two outer rings 26 may also be separated.

The above embodiments are only used to describe the present disclosure and are not intended to limit the present disclosure. Those skilled in the art can make various changes and variations without departing from the spirit and scope of the present disclosure. All equivalent technical solutions also fall within the scope of the present disclosure, and the protection scope of the present disclosure is defined by the claims.

### REFERENCE NUMBER LIST

22, 24 rows of rolling elements

26 outer ring

26a lateral surface

26b recess

26f outer ring hub

28 axle

30 braking element

32 connecting unit

34 fastener

42 hub element

42a first section

42b second section

46 flange

48 the axial direction of the axle

60 inner ring

62 shaft section

SR sealing ring

R transition portion

What is claimed is:

1. A wheel bearing assembly configured to rotatably support an axle, the wheel bearing assembly comprising:
a bearing having at least one outer ring, at least one inner ring and a plurality of rolling elements between the at least one outer ring and the at least one inner ring, and
a hub element,
wherein the at least one inner ring of the bearing is mounted on a shaft section,
wherein the axle extends through the shaft section,
wherein a first end of the axle extends axially beyond the bearing and includes a radial flange,
wherein a first axial end of the hub element is connected to a braking element for braking the axle and a second axial end of the hub element includes an axial first section on a radial outer side of the at least one outer ring and a radial second section extending radially inward from the axial first section,
wherein the radial second section is clamped axially between the radial flange of the axle and the at least one outer ring of the bearing,
wherein the flange, the radial second section of the hub element and the at least one outer ring are fixed to one another by a fastener, and
wherein either:
a sealing ring is arranged between an outer diameter periphery of the at least one outer ring and the radial second section of the hub element to seal a clearance between the radial second section of the hub element and the at least one outer ring, or
the sealing ring is arranged between an outer diameter periphery of an outer hub ring surrounding the at least one outer ring and the radial second section of the hub element to seal a clearance between the radial second section of the hub element and the outer hub ring.

2. The wheel bearing assembly according to claim 1,
wherein the outer diameter periphery of the at least one outer ring or the outer diameter periphery of the outer hub ring includes a recess, and
wherein the sealing ring is mounted in the recess.

3. The wheel bearing assembly according to claim 2,
wherein the recess in axial section has a shape of a first circular arc.

4. The wheel bearing assembly according to claim 1,
wherein a transition portion between the axial first section and the radial second section, in axial section, has a shape of a second circular arc.

5. The wheel bearing assembly according to claim 1,
including a sealant between the radial second section of the hub element and the flange.

6. The wheel bearing assembly according to claim 1,
wherein the bearing comprises a double row tapered roller bearing.

7. The wheel bearing assembly according to claim 6,
wherein the at least one outer ring comprises a single, one-piece, outer ring having a first raceway for guiding a first row of rolling elements of the double row tapered roller bearing and a second raceway for guiding a second row of the rolling elements of the double row tapered roller bearing.

8. The wheel bearing assembly according to claim 2,
including a fastener extending axially through the flange, the radial second section of the hub element and the at least one outer ring of the bearing to mutually secure the flange, the radial second section and the at least one outer ring.

9. The wheel bearing assembly according to claim 2,
wherein the recess in axial section has a shape of a first circular arc,
wherein a transition portion between the axial first section and the radial second section, in axial section, has a shape of a second circular arc, and
including a sealant between the radial second section of the hub element and the flange.

10. A method comprising:
forming a recess for receiving a sealing ring at an outer diameter periphery of a lateral surface of a bearing outer ring or an outer ring hub fitted radially outward of the outer ring,
placing the sealing ring into the recess, and
after placing the sealing ring into the recess, assembling the bearing outer ring or the outer ring hub onto a hub element.
